(19) United States
(12) Patent Application Publication
(10) Pub. No.: US 2025/0330673 A1
(43) Pub. Date: Oct. 23, 2025

(54) USER FEEDBACK AND CONTENT ADAPTATION FOR INFORMATION ASSIMILATION

(71) Applicant: Logitech Europe S.A., Lausanne (CH)

(72) Inventors: Pablo MAINAR JOVANI, Lausanne (CH); Miloš Cernak, Martigny (CH); Jean-Michel CHARDON, Vufflens-la-Ville (CH)

(21) Appl. No.: 18/641,043

(22) Filed: Apr. 19, 2024

(51) Int. Cl. H04N 21/442; H04N 21/4223; H04N 21/435; H04N 21/462; H04N 21/466

(52) U.S. Cl. CPC H04N 21/44218; H04N 21/4223; H04N 21/435; H04N 21/462; H04N 21/4667

(57) ABSTRACT

Embodiments of the disclosure include a method of presenting a video stream that is to be received by a plurality of content consumers, comprising: receiving, by a first electronic device used by a content consumer, the video stream; collecting, by a first processor coupled to a first program of the first electronic device, content consumer data corresponding to the content consumer that is receiving the video stream; receiving, by the first program, the content consumer data; sending, by the first program, first instructions based on the content consumer data to the first processor; and updating, by the first processor, an audible or visible characteristic of the video stream being provided to the content consumer based on the sent first instructions.

### BACKGROUND

### Field

Embodiments of the present disclosure generally relate to a video streaming system and related methods of using the video streaming system described herein.

### Description of the Related Art

Video streaming has become more popular in recent years, thanks in large part to proliferation of high speed Internet and price reductions in camera equipment. For example, in the work place, dedicated video streaming locations exist where rooms and technological resources are dedicated solely to the task of video streaming. In another example, video streams are used to consumer content such as movies, television shows, sporting events, instructional videos, or the like. Furthermore, with the improvements in video gaming, gamers are able to video stream the game they are playing to interested viewers with commentary. Video streaming is used to connect remote users in a variety of scenarios such as a meeting in the workplace, virtual classrooms, social calls, playing video games, watching movies/television shows, or the like. For example, video streaming may take place between a content producer, such as a teacher or an employee running a work meeting, and content consumers such as students or attendees of a work meeting. However, during video streaming, the content displayed to the content consumers is not automatically adaptable. Furthermore, the content producer is unaware on how to adapt their video stream (e.g., presentation slides) in real-time to adapt to the current state (needs) of the content consumers. For example, the content producer and/or the video streaming software application is unaware that content consumers beginning to lose attention, some content consumers have individualized needs, and whether/when some content consumers are having problems comprehending or following the information presented in the video stream.

Additionally, different content consumers are more susceptible to distractions, speak different languages, have issues understanding different accents, have different attention spans, have different levels of fatigue during the presentation, and combinations thereof. Typical video streaming software applications do not have the ability to individualize the content presented to individual content consumers based on their individual needs.

Therefore, there is a need in the art for a software application and related hardware that can alert and provide a content producer in real-time with suggestions to adapt their presentation in real-time based on the needs content consumer(s) and/or provide a different viewing experience to different content consumer based on their needs as content consumers.

### SUMMARY

According to one or more embodiments, a method of presenting a video stream that is to be received by one or more content consumers includes, by a first electronic device used by a content consumer, the video stream collecting, by a first processor coupled to a first program of the first electronic device, content consumer data corresponding to the content consumer that is receiving the video stream, receiving, by the first program, the content consumer data, sending, by the first program, first instructions based on the content consumer data to the first processor; and updating, by the first processor, an audible or visible characteristic of the video stream being provided to the content consumer based on the sent first instructions.

According to one or more embodiments, a video streaming system includes a first electronic device used by a content consumer that is configured to receive a video stream, the first electronic device comprising a first processor coupled to a first camera device and a first program, the first program configured to receive content consumer data corresponding to the content consumer that is receiving the video stream captured by the first camera device and collected by the first processor, and send first instructions based on the content consumer data to the first processor, wherein the first processor is configured to update an audible or visible characteristic of the video stream based on the first instructions.

According to one or more embodiments, an electronic device includes a processor coupled to a camera device and a program, the program configured to receive content consumer data corresponding to a content consumer captured by the camera device and collected by the processor, and send instructions based on the content consumer data to the processor, wherein the controlling processing is configured to update an audible or visible characteristic of a video stream received by the electronic device based on the instructions.

Embodiments of the disclosure may also include an electronic device comprising a program executed by a processor of a camera device, the program configured to: receive content consumer data corresponding to a content consumer captured by the camera device and collected by the processor; and send instructions based on the content consumer data to the processor, wherein the controlling processing is configured to update an audible or visible characteristic of a video stream received by the electronic device based on the instructions.

Embodiments of the disclosure may also include a method of presenting a video stream that is to be received by one or more content consumers, comprising: receiving, by a first electronic device used by a content consumer, the video stream; collecting, by use of a first program executed by a first processor of the first electronic device, content consumer data corresponding to the content consumer that is receiving the video stream; receiving, by use of the first program, the content consumer data; sending, by use of the first program, first instructions based on the content consumer data to the first processor; and updating an audible or visible characteristic of the video stream being provided to the content consumer based on the sent first instructions.

Embodiments of the disclosure may also include a video streaming system comprising: a first electronic device used by a content consumer that is configured to receive a video stream, the first electronic device comprising a first program that is executed by a first processor of a first camera device, the first program configured to: receive content consumer data corresponding to the content consumer that is receiving the video stream captured by the first camera device and collected by the first processor; and send first instructions based on the content consumer data to the first processor, wherein the first processor is configured to update an audible or visible characteristic of the video stream based on the first instructions.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1A is a diagram of a video streaming system, according to one embodiment.

FIG. 1B is a close-up diagram of portions of the video streaming system illustrated in FIG. 1A, according to one embodiment.

FIG. 2 is flow diagram illustrating a method of updating a video stream provided to content consumers, according to one embodiment.

FIG. 3A illustrates a graphical-user-interface (GUI) displaying the video stream to a first content consumer, according to one embodiment.

FIG. 3B illustrates a graphical-user-interface (GUI) displaying the video stream to a second content consumer, according to one embodiment.

FIG. 4 illustrates a graphical-user-interface (GUI) of a content producer, according to one embodiment.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Video streaming is used to connect remote users in a variety of scenarios such as a meeting in the workplace, virtual classrooms, social calls, playing video games, watching movies/television shows, or the like. Video streaming typically includes at least one content producer that provides content to at least one content consumer. The at least one content producer can be a teacher, an employee conducting a work meeting, a host or a server providing content, or the like. The at least one content consumer may be a student attending a virtual lecture, an employee attending a work meeting, an individual streaming a movie or television show from a streaming service, or the like. Conventionally, the content displayed to the content consumers is not automatically adaptable, and content producers are unaware how their content is being perceived by content consumers in-real time. For example, the content producers and/or the video streaming software application is unaware that content consumers are beginning to lose attention, some content consumers have individualized needs, and/or whether/when some content consumers are having problems comprehending/following the information presented in the video stream.

Embodiments of the present disclosure generally relate to a video streaming system and related methods of using the video streaming system described herein. In particular, embodiments herein relate to a video streaming system and related method for individualizing the viewing experience for participants of a video stream based on individual needs of each participant.

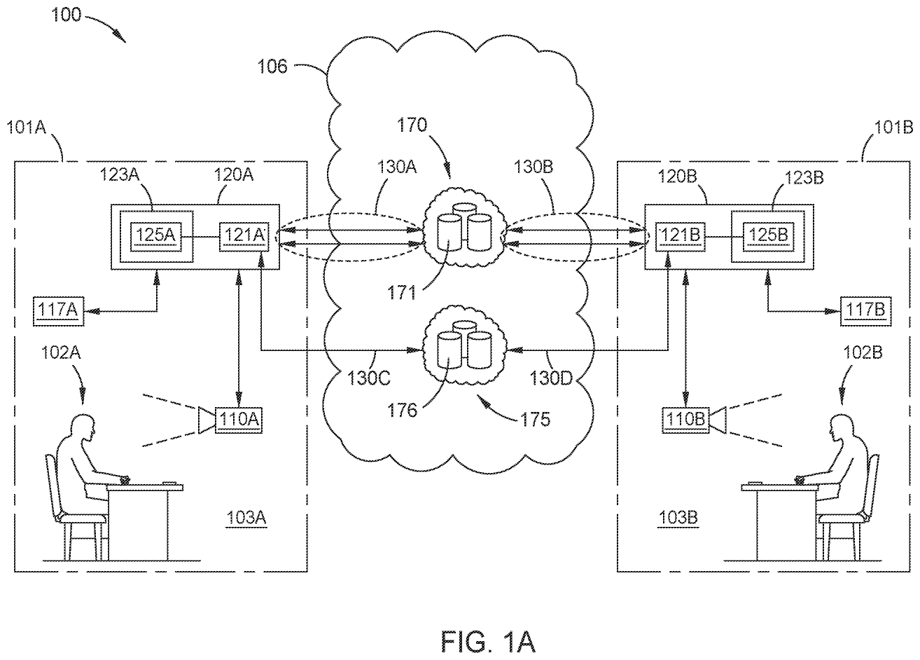

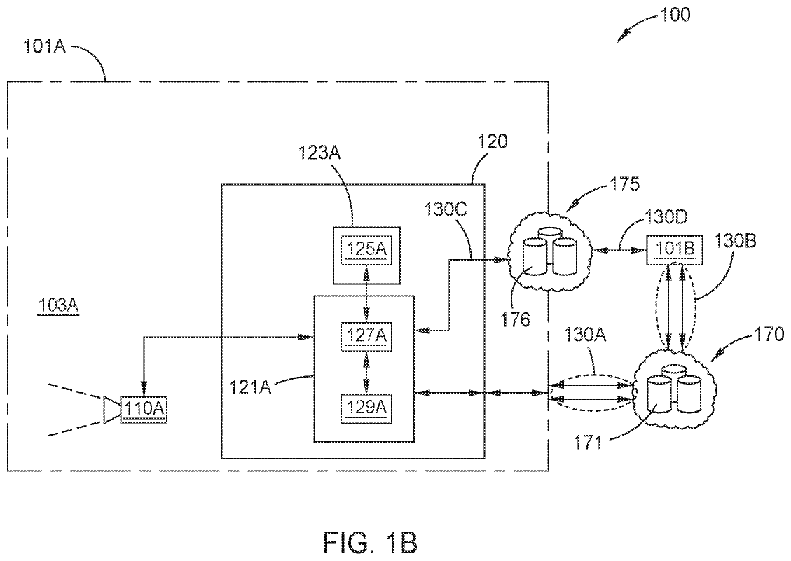

FIG. 1A is a diagram of a video streaming system 100, according to one or more embodiments. The video streaming system 100 includes a video streaming endpoint 101A (i.e., the video streaming environment 103A and related equipment) and a video streaming endpoint 101B (i.e., the video streaming environment 103B and related equipment). The related equipment at each respective video streaming endpoint 101A, 101B can include one or more cameras, at least one microphone, at least one electronic device for providing the video stream from the other video streaming endpoint 101A, 101B to the users, and at least one controlling device for handling the distribution of the different types of data exchanged between the respective video streaming endpoints 101A, 101B. The related equipment for each respective video streaming endpoint 101A, 101B is described in more detail below.

The video streaming endpoint 101B is at a remote location relative to the video streaming endpoint 101A. Stated differently, a content producer may be located at the video streaming endpoint 101A and content consumer(s) may be located at the video streaming endpoint 101B (or vice versa). For example, the video streaming endpoint 101B may include one or more remote locations (video streaming endpoints) that each include video streaming equipment used by at least one content consumer. Stated differently, video streaming endpoint 101B may represent one or more remote locations occupied by one or more users (content consumer(s)). A remote location can be any location where it would not be feasible for a content consumer (i.e., attendee) at the remote location of the video stream to communicate to the content producer and/or any other content consumer at a content producer location (i.e., video streaming endpoint 101A) or other remote locations without the use of an external device (e.g., an electronic device, such as a smart phone, tablet, laptop, microphone, etc.). Thus, in some embodiments, a remote location can be remote from a content producer location if the remote location is (1) in another building relative to content producer location, (2) another room within the same building as content producer location, or (3) even in the same room as the content producer location if it is not feasible or it is undesirable for at least one of two of the attendees to communicate with the other without use of an external device. The video streaming endpoint 101A can be connected to the video streaming endpoint 101B through a network 106. The network 106 generally represents any data communications network suitable for the transmission of video and audio data (e.g., the Internet).

The video streaming system 100 enables the video streaming endpoint 101A to communicate with the video streaming endpoint 101B through a variety of paths. For example, video streaming data (e.g., video and audio data) can be exchanged through a video streaming cloud service 170 (e.g., Microsoft® Skype®, Zoom®, Twitch®, or the like). The video streaming cloud service 170 can include a video streaming node 171 to allow one or more users 102A (content producer(s)) located at the video streaming endpoint 101A to communicate with one or more users 102B (content consumer(s)) located at the video streaming endpoint 101B. Stated differently, the user 102B, as described herein, may refer to one or more users (content consumer(s)) that are each located at different remote locations. In another example, the video streaming endpoint 101A may be a server or a host, such as a video or live television streaming service configured to provide video to the user(s) 102B (i.e., content consumers).

Additionally, auxiliary data can also be exchanged between the respective video streaming endpoints 101A, 101B through the video streaming cloud service 170 to further enhance the interaction between the users 102A, 102B (or the users 102B and the server or host) at the respective video streaming endpoints 101A, 101B. In some embodiments, the auxiliary data can be exchanged using a separate cloud service. This auxiliary data can include any data exchanged between the respective video streaming endpoints 101A, 101B. For example, auxiliary data can include data related to instant messaging applications, screen sharing applications, or electronic document sharing applications. Although the video streaming system 100 shows one cloud service, the data exchanged between the video streaming endpoints can be transmitted using any suitable quantity of cloud services.

The related equipment for the video streaming endpoints 101A, 101B can include cameras, microphones, and display devices. For example, each video streaming endpoint 101A, 101B includes a corresponding camera device, one or more microphones, and an electronic device (e.g., a laptop, personal computer, tablet, smart phone, television, etc.). For example, video streaming endpoint 101A includes a camera device 110A, one or more microphones 117A, and an electronic device 120A. Video streaming endpoint 101B includes a camera device 110B, one or more microphones 117B, and an electronic device 120B. For example, the camera devices 110A, 110B may be a camera included in the electronic devices 120A, 120B or may be an external camera, such as a web cam, connected to the electronic devices 120A, 120B. In other embodiments one or each of the video streaming endpoints 101A, 101B includes an additional camera device, such as a pan and tilt camera device (e.g., a pan, tilt, and zoom camera) that is used to provide additional information regarding the environment at each of the end points during a video streaming activity. In some embodiments, the electronic devices 120A, 120B can transmit the incoming video streaming stream to a larger display device, such as a television, monitor, or a projection screen.

In some embodiments of the video streaming system 100, the camera devices 110A, 110B may record an overview of the corresponding video streaming environment and transmit a selected portion of the recorded overview (e.g., a portion focused on a single user) when a view of a portion is more suitable to transmit to the opposing video streaming endpoint 101A, 101B than a video stream of the overview, such as when a single user is speaking continuously for a long time during the video stream. In one example, the camera devices 110A, 110B are devices that have a high enough image resolution so that they can desirably provide a digital zoom of sub-portions of its field-of-view. Conversely, in other embodiments two or more camera devices may be used to capture additional views that may not be possible with only one camera device.

The electronic devices 120A, 120B of each video streaming endpoint 101A, 101B may include respective controlling processors 121A, 121B that can handle at least some of the communication between the video streaming endpoints 101A, 101B and can also handle communication with the camera devices 110A, 110B of the corresponding video streaming endpoint 101A, 101B. In some embodiments, the electronic devices 120A, 120B of each video streaming endpoint 101A, 101B can include at least one respective controlling processor 121A, 121B that can process, control and distribute the various video streaming data received from the corresponding camera devices 110A, 110B and video streams delivered to or provided from other video streaming locations. In some embodiments, the electronic devices 120A, 120B each include a memory 123A, 123B coupled to the controlling processors 121A, 121B that includes a program 125, such as a program 125A or 125B that provides instructions to a respective controlling processor 121A, 121B to improve a viewing experience of the content consumers. As will be described in more detail below, in some embodiments, the camera device 110B can capture and provide content consumer data to the program 125B located in electronic device 120B that can be used to update (improve) a viewing experience of the user 102B (i.e., the content consumer(s)) based on the received content consumer data.

The program 125B located in electronic device 120B may receive the content consumer data from the camera device 110B and process the content consumer data. The program 125B may provide instructions the controlling processor 121B for updating (improving) the viewing experience for the user 102B (content consumer(s)) based on the content consumer data. For example, based on the instructions, the controlling processor 121B can update an audible or visual characteristic of the video stream. Additionally or alternatively, the program 125B located in electronic device 120B can instruct the controlling processor 121B to generate status signals based on the content consumer data and provide the status signals to the electronic device 120A via a video streaming cloud service 175. The video streaming cloud service 175 can include a status signal node 176 to allow the status signals to be exchanged between the electronic devices 120A, 120B. A status signal as defined herein can include information about a corresponding content consumer's emotional state, attentiveness, and/or content consumer data. The video streaming cloud service 175 may store the status signals and aggregate the content consumer data received from each content consumer so that the aggregated data can be provided to the content producer and/or one or more of the content consumers. The program 125A located in the electronic device 120A may send instructions to the controlling processor 121A based on the status signals that cause the controlling processor 121A to provide suggestions to the content producer on how to update (improve) the video stream in real-time to adapt to the user 102B (e.g., content consumer(s)′) needs. The status signals may also cause the controlling processor 121A to provide feedback (suggestions) to the content producer on how to improve future video streams. In other embodiments, the status signals may be transmitted between electronic devices using video streaming cloud service 175.

In some embodiments, the content consumer data may be used to indicate a level of attentiveness of the user 102B, the current emotional state of the user 102B, or the like. The emotional state of the user 102B may include, but is not limited to, the level of comprehension (confusion) being experienced by the user 102B (i.e., each content consumer), joy, boredom, frustration, stress level, excitement and the like. The content consumer data may include biodata captured using an external device used to track the emotional state of the user 102B as electroencephalogram (EEG) data, the biodata of the user 102B may include video data captured by the camera device 110B located within each remote location, or audio information (audio data) captured by the microphone 117B within each remote location, or scheduling information of the content consumer(s), such as meal times, or the content consumer daily schedule. The scheduling information of the user 102B may be extracted by the program 125B or input by the user 102B.

In some embodiments, the camera device 110B may generate content consumer data by tracking the gaze of the user 102B (i.e., each content consumer at each remote location) and/or the body language of the user 102B (i.e., each content consumer at each remote location) using any suitable software such as facial recognition software, artificial intelligence, machine learning, and/or the like. In some embodiments, tracking the gaze of the user may include, but is not limited to, tracking whether the user 102 is looking at the screen (display), the blinking rate of the user, the duration of gaze fixations, dilation of the pupils, or combinations thereof. Additionally, or alternatively, the microphone 117B may generate content consumer data using biodata that is determined based on audio data provided by the user 102B. The microphone 117B may generate content consumer data by tracking the audio data provided by content consumers including but not limited to, the breathing rate of the user 102B and characteristics of the speech of the user 102B, such as the volume, cadence, tone, or the like using any suitable software such as voice recognition software, artificial intelligence, machine learning, and/or the like. In one or more embodiments, the breathing rate may captured using the camera device 110B and/or an additional near-infrared camera of the electronic device 120B. The camera device 110B and/or the microphone 117B can then provide the content consumer data to the program 125B located within the electronic device 120B.

The program 125B may then use the content consumer data to determine the level of attentiveness and the emotional state of the user 102B (i.e., confusion, concentration, joy, boredom, frustration, excitement, etc.). The content consumer data can be compared with prior content consumer data that is stored in memory of the camera device 110B, or content consumer data learned over time by use of artificial intelligence (AI) software, to determine the emotional state of the user. As noted above, the program 125B may also use content consumer data that includes scheduling information of the user 102B to assess the level of attentiveness and emotional state of the user 102B. In some embodiments, a processor, a memory, and a program 125A, 125B can reside in the camera devices 110A, 110B.

As will be described in more detail below, the program 125B located within the electronic device 120B can process the content consumer data and provide instructions to the controlling processor 121B to improve (update) the viewing experience of the user 102B based on the content consumer data. Additionally or alternatively, the controlling processor 121B, based on instructions from the program 125B, can provide status signals to the electronic device 120A via video streaming cloud service 175 (or video streaming cloud service 170). The program 125B can generate instructions to the controlling processor 121A that cause the controlling processor 121A to generate suggestions to the content producer (user 102A) to improve the level of attentiveness of content consumers based on the content consumer data.

For example, referring back to FIG. 1A, as noted above, the user 102A is the content producer and the user 102B represents at least one content consumer occupying at least one video streaming endpoint 101B. The program 125B located within the electronic device 120B, based on the content consumer data corresponding to the user 102B, can provide instructions to the controlling processor 121B on how to update (improve) the viewing experience for the user 102B. Then, based on the instructions, the controlling processor 121B updates the video stream and/or data provided to the user 102B accordingly. Additionally or alternatively, the program 125B can provide instructions to the controlling processor 121B to send status signals to the electronic device 120A. The program 125A located within the electronic device 120A can process the status signals and then provide instructions to the controlling processor 121A that cause the controlling processor 121A to provide suggestions to the user 102A on how to improve their video streaming presentation, such as increasing their speaking volume or changing the cadence (speed) in which they speak. Furthermore, based on the biodata generated based on audio information included in the content consumer data, the user 102A (i.e., content producer) can be aware of intelligibility of clarity on the end of content consumers. For example, the content consumer may have issues hearing the lecture because they are located in a noisy environment. Thus, the suggestions can include altering the content producer to make recommendations to individual content consumers such as to moving locations. Additionally, based on the aggregated content consumer data captured by the video streaming cloud service 175, the program 125A may provide the content producer suggestions that include feedback on how to improve future video streams. For example, the program 125A can let the content producer know that multiple content consumers lost attention at a specific part of the video streams. This would allow the content producer to update their future video streams (presentations). The instructions provided from the controlling processor 121B can be created by or based on a comparison of the content consumer data corresponding to the user 102B with prior content consumer data that is stored in memory of the camera device 110B, or content consumer data learned over time by use of artificial intelligence (AI) software so as to provide the desired suggestions to the user 102A.

For example, the instructions provided by the program 125B can cause the controlling processor 121B to update (improve) the viewing experience for the user 102B by individualizing an audible or visual characteristic of the video stream for the user 102B. For example, the instructions can cause the controlling processor 121B to individualize the information displayed to the user 102B, filter out sounds that could cause the user 102B to lose attention, increase the audio volume for the user 102B, change the speaking style of the content producer that decrease the cognitive load of the content consumer, send warnings to the user 102B that they are losing focus, provide subtitles to the user 102B, send alarms to recapture the attention of the user 102B, suggest that the user 102B take a break, suggest to the user 102B at the conclusion of the video stream to revisit particular time stamps of the video steam in which the attention level of the user 102B was low, and combinations thereof. In some embodiments, the instructions may be used to update (change) to content presented to content consumers. In some embodiments, changing the speaking style of the content consumer includes, but is not limited to, dynamically changing the tone of the content producer's voice, slowing down the cadence of content producer's speech, softening and lowering the volume of the content producer's speech (i.e., a calming voice), making the content producer's speech monotonous (such as converting the speech to artificial monotonous speech), or the like.

In one or more embodiments, the program 125B can extract information shared by the content producer (user 102A). The program 125B located within the electronic device 120B can analyze the content being shared and extract features, including, but not limited to, a quantity of text being shared, volume, pitch and speech speed of the user 102A, the background color of a presentation slide, font size of text, or combinations thereof. For example, if the user 102A is presenting slides, the program 125B located within the electronic device 120B can extract the quantity of text of a current slide that is being shared, the volume and pitch and speech speed of the user 102A, the background color of the slide being shared, font size of the current slide being shared, or the like. If the program 125B determines, based on the content consumer data and/or content consumer metadata, that the user 102B is losing attention, the program 125B may send instructions to change the amount of content shown on the slides, such as removing extraneous information from the presentation or the related discussion to improve the attention and reduce the confusion of the user 102B. Additionally, the program 125 can generate instructions to change the font size, background color, or any other characteristic of the slide to help improve the attention of user 102B. Furthermore, the program 125B can also send instructions to increase/decrease the volume, the speech speed, or the pitch or the voice of user 102A. Stated differently, each controlling processor 121B and corresponding program 125B located within each content consumers' electronic device can individualize the video stream provided to each content consumer based on each content consumers' need in real-time.

Furthermore, the program 125B located within the electronic device 120B may provide instructions to the controlling processor 121B prior to the start of the video stream to update the video streaming settings (viewing experience) for the user 102B (content consumer(s)) prior to and/or at the commencement of the video stream based on content consumer metadata. The consumer metadata may be stored in memory and/or the program 125B and be based on content consumer data collected and processed during previous video streams. For example, the content consumer metadata may indicate the current attentive level, and emotional state of a corresponding content consumer (user 102b) based on the time of the video stream, the schedule of the content consumer, the subject material to be presented during the video stream, the language spoken by the content producer, the accent of the content producer, ambient noise on the side of the content producer, or the like. Stated differently, based on previously collected content consumer data for each corresponding content consumer, the program 125B can determine what can have a negative effect on the level of attentiveness and/or emotional state of each corresponding content consumer. For example, the content consumer metadata may indicate that a specific content consumer (i.e., user 102B) is fatigued from being in consecutive meetings, has issues paying attention after lunch, is susceptible to being distracted based on a specific sound, has issues understanding the accent of the content producer, does not understand the language spoken by the content producer, or the like. Additionally, or alternatively, the content consumer metadata may be used to predict what the user's emotional state and/or attention level may be based on a subject-matter and/or the task-at-hand. The content consumer metadata may also include a-priori metadata that indicates traits and states of each content consumer related to the personality of each content consumer. For example, the content consumer metadata may indicate that a content consumer will be frustrated, lack attentiveness based on the current subject-matter, and/or find a task-at-hand to be more demanding (or vice versa). The traits and states of each content consumer may be related to the personality of each content consumer may be determined based on the profiles of content consumers, or questionnaires provided to content consumers.

In some embodiments, based on the consumer data and/or metadata, the program 125B may send instructions to the controlling processor 121B to cause the controlling processor 121B to individualize a visual or audible characteristic of the video stream by providing audible and/or visual warnings, and/or updating the visual information displayed a content consumer. For example, the controller processor 121B may generate a warning, remove extraneous information being presented, generate subtitles, sound an alarm, generate a screen flash, increase the speaker volume, change the speaking style of the content producer, and/or the like for user 102B to resolve any emotional issues (e.g., loss of attention or confusion) to improve the viewing experience for the user 102B. In another example, based on the consumer data and/or metadata, the program 125B may provide instructions to the controlling processor 121B to transmit status signals to the program 125B. The program 125A located within the electronic device 120A may send instructions to the controlling processor 121A that cause the controlling processor 121A to provide suggestions to the user 102A based on the received status signals. As noted above, the viewing experience can also be updated for each content consumer at each remote location in the same manner described above.

Although the program(s) 125A, 125B within the video streaming system 100 are described with reference to updating the viewing experience of the content consumer(s), this is for example purposes only. The program(s) 125A, 125B within the video streaming system 100 are also able to update the viewing experience of the content producer(s) (i.e., user 102A). For example, the video streaming system 100 is able to capture and process content producer data and content producer metadata and update the viewing experience of the content producer(s) while a content consumer is presenting/speaking. Furthermore, the viewing experience of the content consumer(s) and the viewing experience of the content producer(s) may be updated using the content consumer and content producer data/metadata simultaneously while a content consumer is presenting.

In some embodiments, the controlling processors 121A, 121B may each include one or more independent processing units so that largely independent tasks can be handled by the separate processing units. For example, in one embodiment, a first processing unit can handle the processing of exchanging/updating the video streams (i.e., the video streams that the users at the two video streaming endpoints 101A, 101B use to communicate during the video stream) between the video streaming endpoints 101A, 101B, and a second processing unit can handle the remainder of the tasks executed by the electronic devices 120A, 120B. Using the two independent processing units can help prevent any interruption to the primary video streams.

The electronic devices 120A, 120B of a given video streaming endpoint 101A, 101B can receive the video streams from a corresponding camera device 110A, 110B. In some cases the camera devices 110A, 110B are part of a hub (e.g., a Universal Serial Bus “USB” hub) that includes more than one camera device that can be placed between the electronic device 120 and the camera device 110. The controlling processors 121A, 121B can determine which of the video streams of the camera devices 110A, 110B to transmit to the opposing video streaming endpoint 101A, 101B. For example, a video stream may begin with a controlling processor 121A, 121B transmitting the video stream. Then the controlling processor 121A, 121B can switch to a video stream that is focused on one individual user who is speaking at that time. The controlling processors 121A, 121B can communicate with the video streaming node 171 of the video streaming cloud service 170 through corresponding first and second video streaming network links 130A, 130B. The controlling processors can send the status signals through corresponding third and fourth video streaming network links 130C, 130D.

The primary video stream received at the electronic devices 120A, 120B from the opposing video streaming endpoint 101A, 101B allows the corresponding user to view and hear the video stream. For example, the controlling processor 121A of the video streaming endpoint 101A can display the primary video stream received from the video streaming endpoint 101B. Similarly, the controlling processor 121B of the video streaming endpoint 101B can display the primary video stream received from the video streaming endpoint 101A.

The controlling processor 121A, 121B of the respective video streaming endpoints 101A, 101B can further communicate with the video streaming cloud service 170 (or another cloud server) so that auxiliary data can be exchanged between the two video streaming endpoints 101A, 101B. The auxiliary data can include data related to instant messaging applications, screen sharing applications, or electronic document sharing applications.

Each video streaming endpoint 101A, 101B further includes one or more electronic devices 120A, 120B that allows the users at the video streaming endpoints 101A, 101B to interact with each other and with the video streaming system 100. Each electronic device 120A, 120B allows the user at a given video streaming endpoint 101A, 10B to receive the primary video stream from the other video streaming endpoint 101A, 10B. Each electronic device 120A, 120B can further be used to receive preview images of non-selected portions of the video streaming environment 103A, 103B of the other video streaming endpoint 101A, 101B. These preview images allow the users at a given video streaming endpoint 101A, 101B to change the view for the incoming primary video stream from the other video streaming endpoint 101A, 101B. In some embodiments, the preview images are visible on a portion of a display of the electronic devices 120A, 120B. In other embodiments, the preview images appear on the display when a user decides to access the preview images.

One or more of the electronic devices 120A, 120B may include, but are not limited to an iPod®, iPhone®, iPad®, Android™ phone, Samsung phone, Samsung Galaxy®, Squeeze™ box, Microsoft Surface®, laptop or other similar device. In some embodiments, the electronic devices 120A, 120B may include two or more electronic devices that are capable of performing the function of displaying images received in a video stream delivered from another video streaming endpoint (e.g., display device, TV, laptop, tablet, etc.) and a device that is capable of receiving input from a user regarding what view that they want to receive based on the received preview images (e.g., laptop, tablet, keyboard, smart phone, etc.).

FIG. 1B is a close-up diagram of portions of the video streaming system 100 showing additional detail of the video streaming endpoint 101A, according to one embodiment. The additional details shown for the video streaming endpoint 101A can also equally apply to the video streaming endpoint 101B shown in FIG. 1A.

FIG. 1B shows additional detail of the electronic device 120A. The electronic device 120A includes the controlling processor 121A and the program 125A. The controlling processor 121A can include a processor 127A, and I/O hardware 129A. In one or more examples, the program 125A is stored in the memory 123A which is coupled to the controlling processor 121A. Furthermore, in some embodiments, the multiple processing units can be used. Moreover, in still other embodiments, the program 125A may be disposed external to the electronic device 120A. In other embodiments, as noted above, the program(s) 125A, 125B may be included in each of the respective camera devices 110A, 110B.

The processor 127A may include a central processing unit (CPU), a digital signal processor (DSP), and/or application-specific integrated circuits (ASIC), and other useful components. The processor 127A may be receive instructions from the program 125A stored in the memory 123A in order to perform various functionalities associated with the video streaming system 100 described herein, such as personalizing the viewing experience for at least one content consumer, providing warnings to content consumer(s), and/or providing feedback to content producer(s) to generate an improved viewing experience for each content consumer. In one or more examples, the program 125A may be triggered at initialization of a video streaming software application (i.e., video streaming cloud service 170) at each video streaming endpoint 101A, 101B and/or by user initiation, such as a user turning on camera device 110, initializing a video stream, or the like. In some examples, the program(s) may run in the background (i.e., are separate from the video streaming application) or may implemented within a video streaming application.

The memory 123A may be any technically feasible type of hardware unit configured to store data. For example, memory 123A could include some form of non-volatile memory, such as a hard disk, a random access memory (RAM) module, a flash memory unit, or a combination of different hardware units configured to store data.

The I/O hardware 129A can include one or more components for enabling the respective controlling processor 121A to communicate with the camera device 110, the microphone 117A, and the opposing video streaming endpoint 101A, 101B. For example, the I/O hardware 129A can include one or more of a USB controller or HDMI controller for communicating with one or more of the camera devices 110, 111 and the microphone 117A. Furthermore, the I/O hardware 129A can also include one or more wired or wireless network interface controllers for communicating with the electronic device 105, the opposing video streaming endpoint 101A, 101B, the video streaming cloud service 170, and/or the video streaming cloud service 175.

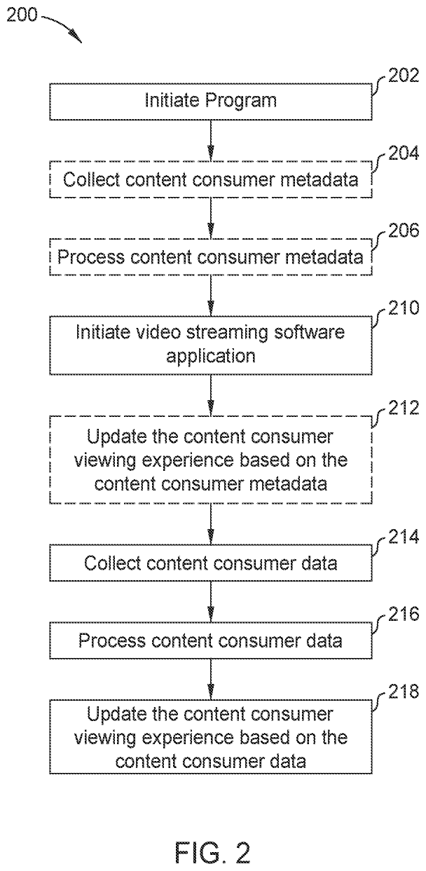

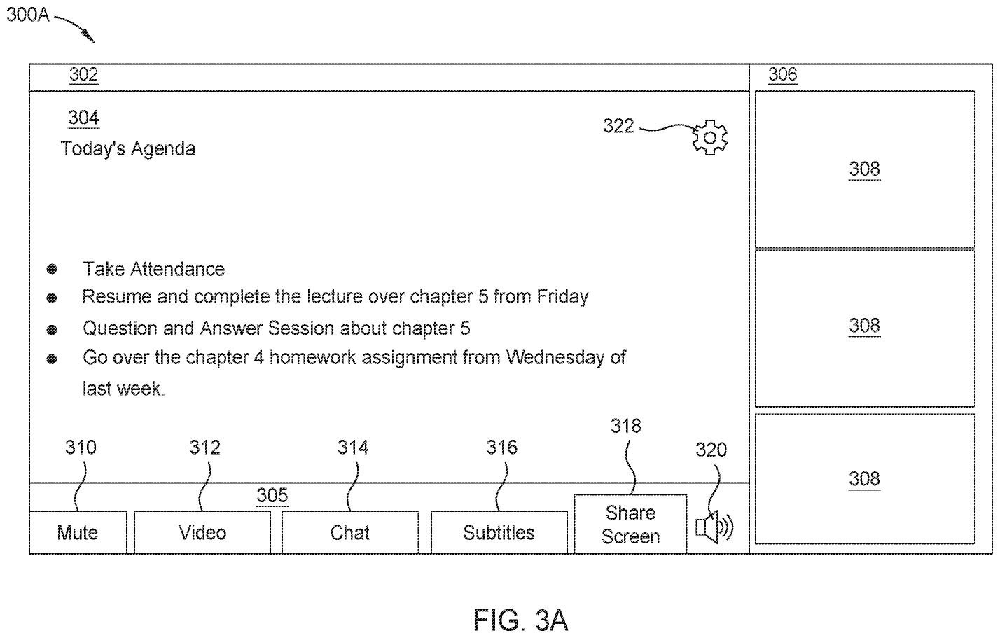

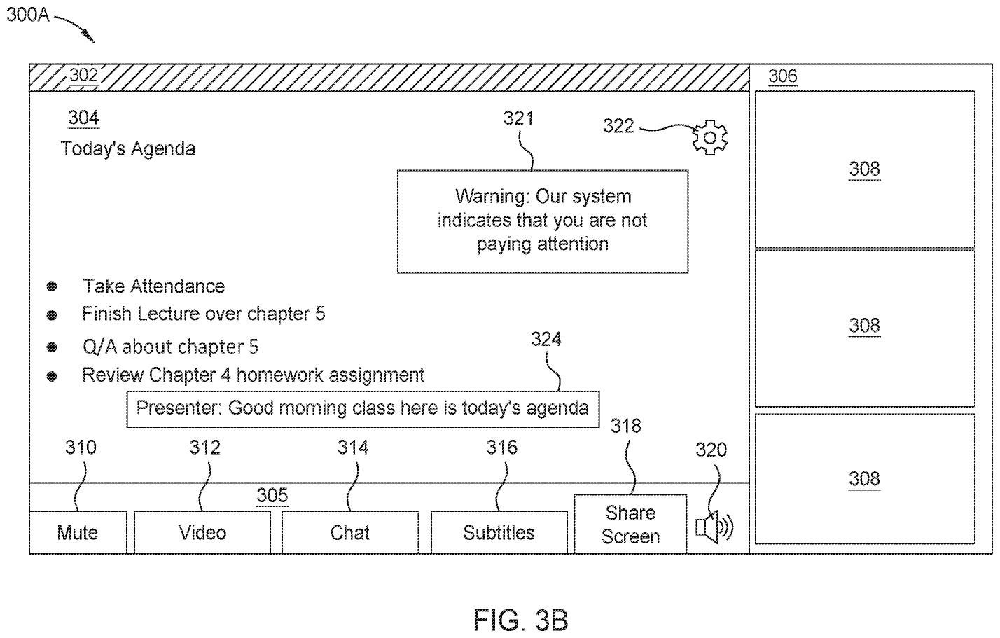

FIG. 2 illustrates a method 200 of updating a video stream provided to content consumers, according to certain embodiments. FIGS. 3A-3B illustrate individual graphical user interfaces (GUIs) displaying individualized viewing experiences for different content consumers of a video stream from a same content producer. For example, FIG. 3A illustrates a GUI 300A displaying the video stream to a first content consumer and FIG. 3B illustrates a GUI 300B displaying the video stream to a second content consumer.

In one or more examples, the format of the GUIs 300A, 300B are based on the video streaming application being used. For example, as shown in FIGS. 3A-3B, the content producer (i.e., user 102A) is a teacher video streaming a lecture and the content consumers are students. Thus, the content producer is using a video software application used for a video stream (i.e., a video lecture). During the video stream one of the GUIs 300A, 300B may be shown on a content consumer's (user 102B) electronic device 120B. In one or more examples, the GUIs 300A, 300B, may include, but are not limited to, a title bar 302 a main display area 304, an options bar 305, a secondary display area 306, and/or a settings prompt 322.

In some embodiments, the main display area 304 consumes the majority of the space of the GUIs 300A, 300B. In some embodiments, the title bar 302, the options bar 305, and the optional secondary display area 306 consume the remainder of the GUIs 300A, 300B. In some embodiments, the title bar 302 is located above the main display area 304 and shows the title of the video stream. For example, as shown in FIGS. 3A-3B, the title bar 302 reads “Class Lecture for Today,” which is the meeting title set by the teacher (the content producer). In other embodiments, the title bar 302 can be located in other areas of the GUIs 300A, 300B such as below the main display area 304 or next to (on the left or right) of the main display area 304. The space consumed by the main display area 304 and the contents displayed in the main display area 304 is determined based on protocols of the video streaming software used (e.g., video streaming cloud service 170), the number of data consumers, content producer settings, and/or content producer settings.

In some examples, the GUIs 300A, 300B include an optional secondary display area 306. In one or more examples, the secondary display area 306 may show the video streaming environment captured at the corresponding video streaming endpoint in which the GUI is displayed and/or the scenes captured at the other video streaming endpoints of the video stream. Stated differently, user(s) at a video streaming endpoint in which the GUI is displayed can see the scene captured in which they are located and/or other captured scenes at other video streaming endpoints in the secondary display area 306. In one or more examples, the secondary display area 306 is always present. In other examples, the secondary display area 306 is triggered by a user. In one or more examples, the presence and/or the contents and location of the secondary display area 306 is based on whether screen sharing is being used, the quantity of users (data consumers and data producers) in the video stream, content consumer settings, content producer settings, and/or the protocols of the video stream software application being used. The secondary display area 306 may be located at any suitable location of the GUIs 300A, 300B. For example the secondary display area 306, may be located above, below, or on the sides of the main display area 304.

### Graphical User Interface Examples

In some embodiments, the secondary display area 306 can be divided into at least one sub-display 308 that shows a video streaming environment captured at one, some, or each video streaming endpoint. In one example, the quantity of sub-displays 308 and/or the arrangement of sub-displays 308 is based on the quantity of video streaming endpoints logged into the video stream and/or a maximum allowable quantity of sub-displays 308. For example, the secondary display area 306 can be divided into at least one sub-display 308. For example, as shown in FIGS. 3A-3B, the secondary display area 306 may be divided into three sub-displays 308 located on the right side of the main display area 304.

In some embodiments, as shown in FIGS. 3A-3B, the content producer is sharing their screen, which triggers the use of the secondary display area 306 in both the GUIs 300A, 300B. Because the main display area 304 is being used to share a screen, the sub-displays 308 may be used to show the video streaming environment captured at the video streaming endpoint corresponding to the content producer, the video streaming environment captured at the corresponding video streaming endpoint in which the GUIs are being displayed, and/or the video streaming environment captured at other video streaming endpoints of content producers. For example, in the GUI 300A, the top sub-display 308 may show the video streaming environment 103A captured at the video streaming endpoint 101A, the middle sub-display 308 may show the scene captured at the video streaming endpoint in which the GUI 300A is displayed, and the bottom sub-display may show the video streaming environment captured at the video streaming endpoint of another content consumer. Similarly, in the GUI 300B, the top sub-display 308 may show the video streaming environment 103A captured at the video streaming endpoint 101A of the content producer, the middle sub-display 308 may show the video streaming environment captured at the video streaming endpoint in which the GUI 300B is displayed, and the bottom sub-display 308 may show the video streaming environment captured at the video streaming endpoint of another content consumer.

In one example, if there are more video streaming endpoints than sub-displays 308 in the video stream, the video streaming environments captured in the video streaming endpoints may be switched to show the video streaming environment captured at a video streaming endpoint in which a user is speaking. For example, one out of the three sub-displays 308 may be configured to switch between video streaming endpoints in which users are speaking. In another example, a sub-display 308 may be reserved to show the video streaming environment captured at the video streaming endpoint of the content producer. In another example a sub-display 308 may be reserved to show the video streaming environment captured at the video streaming endpoint at which the GUI is being displayed.

In some embodiments, the sub-displays 308 may be ordered and arranged in any suitable manner. For example, if the secondary display area 306 is located on a side of the main display, the sub-displays 308 may be arranged in one or more columns. In another example, if the secondary display area 306 is located on the top or bottom of the main display area 304 the sub-displays 308 may be arranged in one or more rows. The sub-displays 308 may be ordered and arranged in the same or a different manner in each of the GUIs 300A, 300B. For example, as shown in FIGS. 3A and 3B the sub-displays 308 may be arranged in a single column. The sub-displays 308 may show the video streaming environment captured at every video streaming endpoint or some of the video streaming endpoints. In other examples, the quantity of sub-displays 308 is determined based on the quantity of video streaming endpoints and a maximum allowable quantity of sub-displays 308 set by the protocol of the video streaming software application or content consumer settings.

In some embodiments if screen sharing is not being used, the secondary display area 306 is optional. If the secondary display area 306 is not being used then the entire main display area 304 may rotated between the video streaming environments captured at video streaming endpoints in which a user that is speaking or remain on the scene captured at the video streaming endpoint of the content producer. In other examples, the main display area 304 may show some or all the video streaming environments captured at video streaming endpoints subdivided and arranged in a grid based on an allowable maximum number of subdivisions of the video streaming software and/or and user settings. For example, if there are more video streaming endpoints than the maximum number of subdivisions, the subdivisions may be organized into a grid that emphasizes the users at video streaming endpoints that speak during the video stream. For example, if a user speaks, the scene captured at the corresponding video streaming endpoint may be displayed in a subdivision of the main display area 304. If the user speaking is not already being shown in a subdivision, the user speaking may replace a user shown in a subdivision that has not spoken during the stream. In another example, the user speaking is emphasized such as illumination the border of the subdivision occupied by the user that is speaking.

In some examples, in which the secondary display area 306 is not used, the video streaming environment captured at the video streaming endpoint in which the GUI is being displayed may be shown as a pop-up window that overlays a main display area 304 at a corner of the main display area. For example, the GUI 300A may have a pop-up window that shows the video streaming environment captured by the camera device 110 corresponding to the video streaming endpoint in which the GUI 300A is displayed. The GUI 300B may have a pop-up window that shows the scene captured by the camera device 110 corresponding to the video streaming endpoint in which the GUI 300B is displayed.

As will be described in more detail below, in one or more examples, the content streamed onto the main display area 304 is updated for each content consumer and/or individual content consumer(s) based on the status signals received by a program 125.

In some embodiments, the options bar 305 may occupy a portion of the GUIs 300A, 300B. For example, the options bar 305 may occupy a portion of the GUIs 300A, 300B on the sides, above, or below the main display area 304. For example, as shown in FIGS. 3A-3B, the options bar 305 is located below the main display area 304. In other examples, the options bar 305 overlays the main display area. In some embodiments, the options bar 305 includes prompts that may selected (enabled/disabled) by the content producer, the content consumers, and/or the controlling processor 121 based on instructions from the corresponding program 125. For example, the prompts include, but are not limited to, a mute prompt 310, a video prompt 312, a chat prompt 314, a subtitles prompt 316, a share screen prompt 318, a volume prompt 320. The options bar 305 may include any suitable prompts. Based on the settings of the video streaming software application, or content producer settings, some of the prompts in the options bar 305 cannot be enabled/disabled by content consumers.

In some embodiments, the mute prompt 310 may be selected by a user at each video streaming endpoint to mute/unmute the corresponding microphone 117B. In one or more examples, the content producer and/or the corresponding controlling processor 121A may have the ability to mute/unmute the microphones 117B at each of the video streaming endpoints of the content consumers. In another example, the content consumers do not have the ability to select/deselect the mute prompt 310.

In some embodiments, the video prompt 312 may be selected/deselected by a user at each video streaming endpoint to enable/disable the camera device 110B. In one or more examples, the content producer and/or the program 125A, 125B may have the ability to enable/disable the camera device 110B at each of the video streaming endpoints of the content consumers. In one or more examples, if the camera device at a video streaming endpoint is disabled, words are used to identify the user(s) at a video streaming endpoint, such as a full name, a username, or initials. In another example, the content consumers do not have the ability to enable/disable (i.e., select/deselect) the video prompt 312.

In some embodiments, the chat prompt 314 may be selected by a user at each video streaming endpoint. If the chat prompt 314 is selected, a chat between each video streaming endpoint in the video stream is becomes visible which allows users to chat with one another during the presentation and/or ask questions to the content producer.

In some embodiments, the subtitles prompt 316 may be selected/deselected by a user at each video streaming endpoint to enable/disable subtitles. If subtitles are enabled, the subtitles may be in the same language spoken by the user(s) in the video stream or in the native language of the user(s) at the video streaming endpoint in which the GUI is being displayed. In one or more example, based on the status signals, the controlling processor 121B, based on instructions received by the corresponding program 125B, is able to initiate subtiles and specify the language of the subtiles. This will be described in more detail below. If the subtitles prompt 316 is enabled, the subtitles will be overlaid over a portion of the main display area 304. In another example, the content consumers do not have the ability to enable/disable (i.e., select/deselect) the subtitles prompt 316.

In some embodiments, selecting/deselecting the share screen prompt 318 allows a user to share their screen. In some embodiments, the last user to select the share screen prompt 318 is the screen that is shared. In another example, the content consumers do not have the ability to enable (i.e., select/deselect) screen sharing. As will be described in more detail below, if a user is sharing their screen, the controlling processor 121B, based on instructions from the corresponding controller, program 125B may individualize the content display on different GUIs at different video streaming endpoints based on the status signals.

In some embodiments, the settings prompt 322 allows the corresponding user to change the settings of the video stream, such as the user background, the audio source, the video source, or the like.

### Video Streaming Processing Example

Referring to FIG. 2, at activity 202, the programs 125A, 125B located in each electronic device 120A, 120B are initiated. In one example, if the program(s) are located within the electronic devices 120A, 120B, the programs are initiated by a respective controlling processor 121A, 121B. In other embodiments, if the programs 125A, 125B are located in the camera devices 110A, 110B, a controlling processor located in each camera device is used to initiate the respective program 125A, 125B.

In some embodiments, each program 125A, 125B may run in the background separate from a video streaming software application. In another embodiment, each program 125A, 125B is implemented in the video streaming software application. Each program 125A, 125B may be initiated at the start-up of each electronic device 120A, 120B, may be initiated by the user opening a video streaming software application (e.g., video streaming cloud service 170), and/or may be initiated by enabling of a corresponding camera device 110A, 110B.

At activity 204 content consumer metadata is collected. In some embodiments activity 204 is optional. Each program 125B located within an electronic device used by a content consumer (electronic device 120B) collects user metadata at the initialization, and prior to commencement the video stream. In one or more examples, the content consumer metadata may be based on previously collected content consumer data. For example, the program 125B located within electronic device 120B collects content consumer metadata corresponding to the user 102B. The content consumer metadata may be collected from and/or during prior video streaming activities, from user entered information stored in a database, or other similar metadata collection process.

The content consumer metadata may be used to instruct a corresponding controlling processor (controlling processor 121B) to update the video stream (the viewing experience) of each content consumer based on information stored within the metadata. For example, the content consumer metadata information may be associated with log-in information of a content consumer such as a username. The content consumer metadata may include, but is not limited to, how many video streams (e.g., meetings, lectures, or the like) the content consumer participated in that day, information regarding the content consumer's attention level at certain times a day, any known distractions that sway the attention of the content consumer, the current emotional state of the content consumer, the native language spoken by the content consumer, any accents the content consumer has issues understanding, or combinations thereof. For example, if a content consumer has been attending multiple video streams or consecutive video streams, the content consumer's attention span may be shortened. The content consumer metadata may include information regarding the content consumer's attention at that time of day. For example, the content consumer may be a morning person, an evening person, has trouble focusing before/after meals, or the like. Furthermore, the content consumer metadata may include information about what sways the attention of the content consumer such as sounds (e.g., a bell), whether the user needs subtitles because the audio of the video stream is in a language the content consumer does not understand or in an accent the content consumer struggles to comprehend. Additionally, or alternatively, the content consumer metadata may be used to predict what the user's emotional state and/or attention level may be based on the task-at-hand. The content consumer metadata may also include a-priori metadata that indicates traits and states of each content consumer based on the subject matter/task-at-hand. For example, the content consumer metadata may indicate that a content consumer will be frustrated or lack attentiveness based on a certain subject-matter, and/or find a task-at-hand more demanding. The traits and states of each content consumer can be related to the personality of each content consumer. For example, the content consumer metadata may determine that a student finds (or will find) a math lecture to be frustrating and/or more demanding. The content consumer metadata is stored based on biodata collected and processed during other previous video streams and/or questionnaires provided to users using the same manner described below with respect to activities 214-216. Additionally, in one or more embodiments, the program 125B can extract information shared by the content producer (user 102A).

At activity 206, each program 125A, 125B located within an electronic device used by a content consumer processes the content consumer metadata. For example, the program 125B located within electronic device 120B, using the content consumer metadata stored in memory, determines the level of attentiveness of the user 102B based on the time of day and/or the user's schedule (i.e., meals and other video streams attended), the emotional state of the user, the language(s) spoken/understood by the user as compared to the language spoken by the content producer, accents the user has issues comprehending as compared to the accent of the content producer, the emotional state of the user based on the subject matter or task-at-hand, or the like.

At activity 210, the video streaming software application (i.e., video streaming cloud service 170) and the video stream are initiated on each electronic device 120A, 120B. For example, the user 102A initiates the video streaming software application on electronic device 120A. The user 102B initiates the video streaming software application on electronic device 120B.

At activity 212, the each content consumer's viewing experience (i.e. visual and/or audio characteristics of the video stream) is updated based on the corresponding content consumer metadata. For example, the program 125B located within electronic device 120B may generate and provide instructions to controlling processor 121B which causes the controlling processor 121B to update the viewing experience of the user 102B. Activity 212 is optional. Activity 212 may only be performed if content consumer metadata is collected and processed in optional activities 204-206.

For example, FIGS. 3A-3B, illustrate a GUI 300A displayed on an electronic device of a first content consumer (first user) and a GUI 300B displayed on an electronic device used by a second content consumer (second user) attending a same video stream. As described above, the video stream attended by the first and second content consumers is a lecture being held by a content producer (teacher) that is sharing a lecture slide (screen sharing). Also, as described above, the program 125B located within the electronic device 120B can analyze the content being shared and extract features, including, but not limited to, a quantity of text being shared, volume, pitch and speech speed of the user 102A, the background color of a presentation slide, font size of text, or combinations thereof. Based on the content consumer metadata corresponding to the first content consumer, at the current time, the first content consumer is prone to paying attention, is in a happy emotional state, and is able to understand the content producer at a high level. The GUI 300A shows the lecture slide, as presented by the content producer. On the other hand, based on the content consumer metadata corresponding to the second content consumer, the second content consumer is prone to losing attention, is in a poor emotional state, is prone to being distracted by a sound in the content producer's presentation or background noise currently being transmitted in the video streaming environment 103A, and/or is unfamiliar with the subject matter of the lecture. For example, the content consumer metadata corresponding to the second content consumer may indicate that the second content consumer constantly shows signs of confusion during the subject matter being discussed in the lecture, the second content consumer has been in lectures all day, finds the current task-at-hand to be demanding, the lecture is during a meal time of the second content consumer, or the like. Therefore, as shown in FIG. 3B, to capture the attention of the second content consumer the program 125B located within the electronic device used by the second content consumer (i.e., electronic device 120B) can send instructions, based on the content consumer metadata corresponding to the second content consumer and the determined features of the content being shared that cause, but are not limited to, the GUI 300B to display less (abbreviated) text to the second content consumer to maintain the second content consumer's attention, which cause the title bar 302 to flash periodically, or transmit a warning 321 indicating to the second content consumer that they are not paying attention, or combinations thereof. Additionally, based on the extracted features of the content being shared (i.e., the slide), the program 125B can send instructions that cause the font size, background color, or any other characteristic of the slide displayed on the GUI 300B to help improve the attention of the second content consumer. The actions provided or initiated by the controlling processor 121B that are used to capture the attention of the second content consumer can be scheduled to be automatically provided at desired intervals based on content consumer metadata or be provided based at least partially on real-time detected attributes of the second content consumer. The detected attributes can be obtained from audible or visual information collected by a camera device 110B, the microphone 117B, or other similar device. Additionally, to capture and maintain the attention of the second content consumer, the program located within the electronic device used by the second content consumer (i.e., electronic device 120B) may provide instructions, based on the content consumer metadata corresponding to the second content consumer and the determined features of the content being shared, that cause the volume of video stream to be increased, or filter out any sounds that are prone to distract the second content consumer (e.g., church bells, construction, traffic noise) on the content producer's side. In some embodiments, the speaking style of the content producer may be changed to improve the attentiveness and/or emotional state of the second content consumer. For example, the tone and/or pitch of the content producer's speech may be dynamically changed, the cadence of content producer's speech, softening and lowering the volume of the content producer's speech (i.e., a calming voice), the content producer's speech may be converted into monotonous speech (such artificial monotonous speech), or the like. In some embodiments, each program located within the electronic device used by each content consumer filter out all ambient noise for all content consumers to improve the viewing experience for all content consumers. In some embodiments, the instructions may cause suggestions to be provided to the second content consumer that suggest the second content consumer revisit particular time stamps of the video stream in which the attention level of the user 102B was low at the conclusion of the video stream (lecture).

Furthermore, as noted above, if the program 125B located within the second content consumer's electronic device (i.e., electronic device 120B) determines that the video stream is in a language not spoken by the second content consumer, the program 125B within the electronic device used by the second content consumer (i.e., electronic device 120B) can send instructions to a separate program (e.g., program 125A) to generate subtitles 324 that can be overlaid on the main display area 304 in a language second content consumer can understand in the GUI 300B. In another example, if the program 125B within the electronic device used by the second content consumer (i.e., electronic device 120B) determines that the content producer has a strong accent and the second content consumer's metadata indicates that content producer's accent typically causes the second content consumer to show signs of confusion, the program 125B within the electronic device used by the second content consumer (i.e., electronic device 120B) may increase the volume and/or display subtitles 324 in the GUI 300B.

At activity 214, content consumer data is collected. As noted above, the content consumer data may include biodata such captured using an external device used to track data consumers as electroencephalogram (EEG) data and/or biodata captured by each camera device and microphone device located within each remote location occupied by a content consumer (i.e., camera device 110B), or scheduling information of each content consumer (such as meal times, or the content consumer schedule that day). For example, the camera device(s) located within each content consumer's electronic device (i.e., camera device 110B) may generate content consumer data by tracking the gaze of each content consumer and/or the body language of each content consumer and provide the content consumer data to the respective program 125. The content consumer data can be collected throughout the video stream. In one example, the collected content consumer data can be obtained from audible or visual information collected by a camera device 110B or other similar device.

At activity 216, each program 125B within each electronic device used by content consumers (i.e., electronic device 120B) processes the content consumer data in real-time to track the level of attentiveness and/or the emotional state of each content consumer (i.e., confusion, concentration, joy, boredom, frustration, excitement, etc.). As noted above, each program 125B may also use content consumer data that includes scheduling information of a content consumer to assess the attention and emotional state of the content consumer and extract features from the content being shared. Each program 125B can provide instructions to the corresponding controlling processor within the same video streaming endpoint (i.e., controlling processor 121B) to improve the viewing experience (i.e., update visual and/or audio characteristics of the video stream) of the corresponding content consumer. Additionally or alternatively, each program 125B can provide each corresponding controlling processor (e.g., controlling processor 121B) with instructions that cause each corresponding controlling processor (e.g., controlling processor 121B) to provide status signals to the controlling processor (e.g., controlling processor 121A) located within the electronic device (i.e., electronic device 120A) used by a content producer, via video streaming cloud service 175. The program 125A located within the electronic device used by a content producer (e.g., electronic device 120A) can generate instructions to the corresponding controlling processor (e.g., controlling processor 121A) which cause the controlling processor to generate suggestions to the content producer (user 102A) to improve their video streaming presentation (i.e., update an audible or visible characteristic of the video stream). As noted above, the content consumer's viewing experience can improved by allowing one or more of the programs (e.g., program 125A or 125B) cause adjustments to be made to the audio or video content that the content consumer is receiving and/or notifying and causing a content provider to make adjustments to their presentation based on feedback received regarding their presentation or input received relating to one or more content consumer's experience.

In some embodiments, the current attentiveness and/or emotional state of the user may be determined based on the body language of the content consumer, the gaze of the content consumer, the breathing rate of the content consumer, the speech of the content consumer, or the like. For example, based on a comparison of previously collected content consumer data and the currently collected consumer data, the program can determine that a user is lacking attentiveness or is in a poor emotional state because they are fidgeting or that they are not continuously not aligning their gaze with the screen, have a high blinking rate, dilated pupils, and/or a high breathing rate. For example, the content consumer data can be compared with prior content consumer data that is stored in memory of the camera device 110B, or content consumer data learned over time by use of artificial intelligence (AI) software, to determine the emotional state of the user. In some embodiments, the current attentiveness and/or emotional state of the user can be determined based on the biodata generated from audio data from the user (content consumer). For example, based previous content consumer data corresponding to the user's voice, the program can determine that the user is frustrated, annoyed, or lacking attention based on the cadence, tone, and/or volume of the user's speech.

At activity 218, the viewing experience of content consumer(s) is updated (improved). The experience of the content consumer(s) is updated by the corresponding controlling processors (e.g., controlling processor 121B) located within the electronic devices used by content consumers (i.e., electronic device 120B). Additionally or alternatively, the viewing experience of the content consumers may be updated based on the suggestions provided to the content producer. Stated differently, each program 125B located within the electronic devices (e.g., electronic device 120B) used by content consumers can provide each corresponding controlling processor (e.g., controlling processor 121B) with instructions that cause each corresponding controlling processor (e.g., controlling processor 121B) to provide status signals to the controlling processor (e.g., controlling processor 121A) located within the electronic device (e.g., electronic device 120A) used by the content producer. The controlling processor (e.g., controlling processor 121A) located within the electronic device used by content producer (e.g., electronic device 120A) provides the status signals to the program 125A located within the electronic device used by the content producer. The program 125A located within the electronic device used by content producer (e.g., electronic device 120A) can generate instructions to the corresponding controlling processor (e.g., controlling processor 121A) that cause the controlling processor (e.g., controlling processor 121A) to generate suggestions to the content producer to improve their video streaming presentation (i.e., update an audible or visible characteristic of the video stream).

In one or more examples, each controlling processor (i.e., controlling processor 121B) located within the electronic devices used by content consumers (i.e., electronic device 120B) can update the video streams in the same manner described in activity 212 based on the content consumer data and the extracted features of the content being shared. The instructions/status signals generated based on content consumer data overrides the instructions/status signals generated based on content consumer metadata.

Referring back to FIGS. 3A-3B, based on the content consumer data received by the program 125A located within the electronic device used by the first content consumer, the first content consumer at the current time, is paying attention, is in a happy emotional state, and/or is understanding the contented being presented by the content producer. Therefore, the GUI 300A shows the lecture slide, as presented by the content producer. On the other hand, the content consumer data corresponding to the second content consumer shows that the second content consumer is losing attention, is in a poor emotional state, is being distracted by sound in the content producer's presentation or background noise currently being transmitted on the content producer's side, and/or is not understanding the content being presented by the content producer. For example, the instructions provided by the program 125A located within the electronic device used by the second content consumer may indicate that the second content consumer is showing signs of confusion, the second content consumer is tired, the second content consumer is distracted, or the like. Therefore, as shown in FIG. 3B, to capture the attention of the second content consumer the program 125A can send instructions that cause, but are not limited to, the GUI 300B to display less (abbreviated) text to the second content consumer to maintain the second content consumer's attention, which cause the title bar 302 to flash periodically, or transmit a warning 321 indicating to the second content consumer that they are not paying attention, or combinations thereof. Additionally, to capture and maintain the attention of the second content consumer, the program 125B may provide instructions that cause the volume of video stream to be increased, changes to the content producer's speech, or filter out any sounds that are prone to distract the second content consumer (e.g., church bells, construction, traffic noise) on the content producer's side. In some embodiments, each program located within each of the electronic devices used by each content consumer can filter out all ambient noise for all content consumers to improve the viewing experience for all content consumers. In another example, if the program 125B located within the electronic device used by the second content consumer determines that the content producer has a strong accent which can be the cause of the second content consumer's confusion, the program 125B may generate instructions that cause the corresponding controlling processor to increase the volume and/or display the subtitles 324 in the GUI 300B.

As noted above, the content consumer data supersedes the content consumer metadata (or vice versa). For example if the content consumer data indicated the video stream volume needs to be increased/decreased the volume is increased/decreased based on the content consumer data (or vice versa). As another example, if the content consumer data indicates that the subtitles need to be displayed but the content consumer metadata indicated that subtitles do not need to be displayed, subtitles are displayed (or vice versa).

Although the method 200 is described with reference to updating the viewing experience of the content consumer(s) this is for example purposes only. The program(s) 125A, 125B within the video streaming system 100 are also able to update the viewing experience of the content producer(s) (i.e., user 102A) in the same manner described above. For example, if a content consumer is speaking/presenting during a video stream, the video streaming system 100 is able to capture and process content producer data and content producer metadata and update the viewing experience of the content producer(s). Furthermore, the viewing experience of the content consumer(s) and the viewing experience of the content producer(s) may be updated using the content consumer and content producer data/metadata simultaneously while a content consumer is presenting.

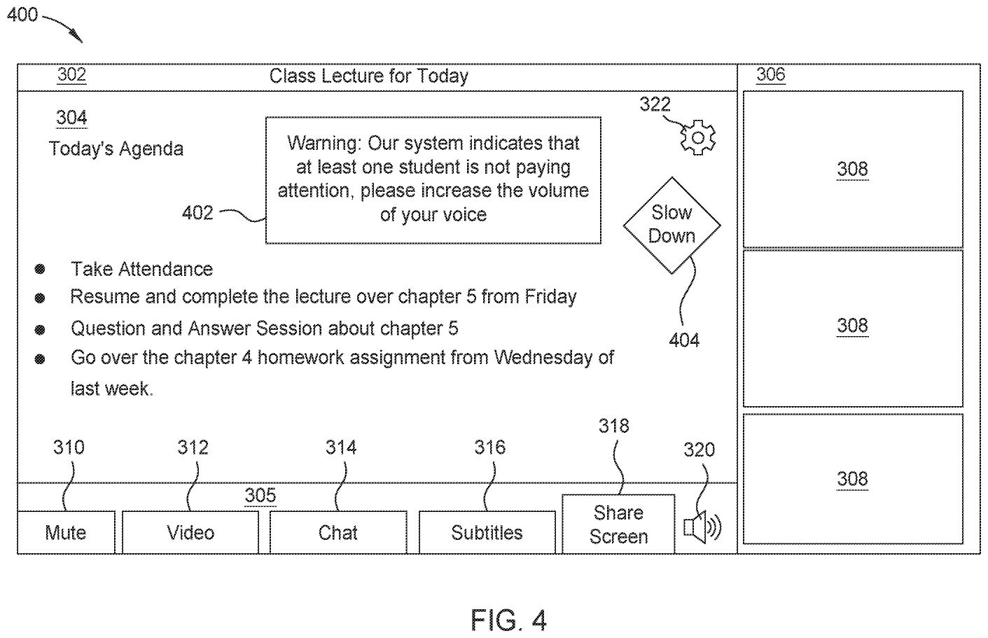

FIG. 4 illustrates a graphical user interface (GUIs) of a content producer according to one or more embodiments. As shown in FIG. 4, a GUI 400 on the content producer side includes the same layout as the GUIs 300A and 300B on the content consumer's side. As described above, based on the status signals received from the video streaming endpoint(s) occupied by content consumer(s), the controlling processor 121 located in the video streaming endpoint of the content producer can display suggestions on the GUI 400 to improve the viewing experience of the content consumers. For example, the suggestions include, but are not limited to, a warning pop-up 402 that indicates at least one student (content consumer) is losing focus and a suggestion increase the volume of the video stream (e.g., to speak louder), provide recommendations to a content consumer (i.e., change your location) or a suggestion pop-up that includes a suggestion for the speaker to slow down the audio of the video stream (e.g., suggesting that the content producer slow down the cadence of their voice, by suggesting to “slow down”). Additionally, at the conclusion of the video stream, the GUI 400 may display suggestions to the content producer that includes feedback for future presentations based on the aggregated content consumer data in the same manner described above. As noted above, the content consumer's viewing experience can improved based on the notification that the content being presented is not being received in a desired manner. The received notification may then cause the content provider to make adjustments to their presentation based on feedback received regarding their presentation or input received relating to one or more content consumer's experience.

In one or more examples, if a content consumer takes over speaking or is presenting something during the video stream, the suggestions shown in GUI 400 can be provided to the GUI of the content consumer that is speaking. For example, the content consumer corresponding to the GUI 300A is speaking, the suggestions can be displayed on the GUI 300A based on content producer and content consumer data/metadata. Furthermore, if a content consumer is speaking, the GUI 400 may be updated in the same manner as GUIs 300A and 300B.

What is claimed is:

1. A method of presenting a video stream that is to be received by one or more content consumers, comprising:
receiving, by a first electronic device used by a content consumer, the video stream;
collecting, by use of a first program executed by a first processor of the first electronic device, content consumer data corresponding to the content consumer that is receiving the video stream;
receiving, by use of the first program, the content consumer data;
sending, by use of the first program, first instructions based on the content consumer data to the first processor; and
updating an audible or visible characteristic of the video stream being provided to the content consumer based on the sent first instructions.

2. The method of claim 1, wherein updating an audible or visible characteristic of the video stream being provided to the content consumer comprises increasing a volume of the video stream, adding subtitles to the video stream, reducing an amount of content provided in the video stream, filtering out sounds during the video stream, changing a speaking style a content producer, and combinations thereof.

3. The method of claim 1, wherein the content consumer data includes information relating to an emotional state of the content consumer.

4. The method of claim 1, wherein the content consumer data comprises biodata of the content consumer, and scheduling information of the content consumer.

5. The method of claim 3, wherein the emotional state of the content consumer at least one of a level of confusion, a level of attentiveness, and a level of comprehension of the content consumer.

6. The method of claim 1, further comprising:
providing, by use of the first processor, status signals to a second program in a second electronic device used by a content producer that is in communication with the first electronic device based on the first instructions;
providing, by use of the second program in the second electronic device, second instructions to a second processor in the second electronic device based on the status signals; and
providing, by use of the second processor, suggestions to the content producer on how to update an audible or visible characteristic of the video stream based on the second instructions.

7. The method of claim 6, wherein the suggestions include a suggestion to increase a volume of audio of the video stream, slow down a cadence of audio of the video stream, provide recommendations to the content consumer, or combinations thereof.

8. The method of claim 1, further comprising:
collecting, by use of the first program, content consumer metadata corresponding to the content consumer prior to initiation of the video stream;
sending, by use of the first program, second instructions based on the content consumer metadata to the first processor in the first electronic device; and
updating, by use of the first processor, an audible or visible characteristic of the video stream based on the second instructions.

9. The method of claim 8, wherein the content consumer metadata is based on content consumer data collected and processed during previous video streams.

10. A video streaming system comprising:
a first electronic device used by a content consumer that is configured to receive a video stream, the first electronic device comprising a first program that is executed by a first processor of a first camera device, the first program configured to:
receive content consumer data corresponding to the content consumer that is receiving the video stream captured by the first camera device and collected by the first processor; and
send first instructions based on the content consumer data to the first processor, wherein the first processor is configured to update an audible or visible characteristic of the video stream based on the first instructions.

11. The video streaming system of claim 10, wherein first processor is configured to update an audible or visible characteristic of the video stream by increasing a volume of the video stream, adding subtitles to the video stream, reducing an amount of content provided in the video stream, filtering out sounds during the video stream, changing a speaking style of a content producer, and combinations thereof.

12. The video streaming system of claim 10, wherein the content consumer data includes an emotional state of the content consumer.

13. The video streaming system of claim 10, wherein the content consumer data comprises at least one of biodata of the content consumer, and scheduling information of the content consumer.

14. The video streaming system of claim 12, wherein the emotional state of the content consumer at least one of a level of confusion, a level of attentiveness, and a level of comprehension of the content consumer.

15. The video streaming system of claim 13, wherein the first processor is further configured to provide status signals to a second program in a second electronic device of the video streaming system used by a content producer based on the first instructions, and the second electronic device is configured to generate suggestions on how to update an audible or visible characteristic of the video stream based on the status signals.

16. The video streaming system of claim 10, wherein the program is further configured to:
collect content consumer metadata corresponding to the content consumer prior to initiation of the video stream; and
provide second instructions based on the content consumer metadata to the first processor, wherein the first processor is configured to update an audible or visible characteristic of the video stream based on the second instructions.

17. An electronic device comprising:
a program executed by a processor of a camera device, the program configured to:
receive content consumer data corresponding to a content consumer captured by the camera device and collected by the processor; and
send instructions based on the content consumer data to the processor, wherein the processor is configured to update an audible or visible characteristic of a video stream received by the electronic device based on the instructions.

18. The electronic device of claim 17, wherein the camera device and the program are disposed within the electronic device.

19. The electronic device of claim 17, wherein the camera device is external to the electronic device and the program is disposed within the camera device.

20. The electronic device of claim 17, wherein the content consumer data comprises at least one of biodata of the content consumer, and scheduling information of the content consumer.
